(19) United States
(12) Patent Application Publication
(10) Pub. No.: US 2008/0233807 A1
(43) Pub. Date: Sep. 25, 2008

(54) Terminal block assemblies and methods for making the same

(75) Inventors: G. William Newton, Durham, NC (US); Brian E. Burch, Creedmoor, NC (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(73) Assignee: Trimm, Inc.

(21) Appl. No.: 11/725,968

(22) Filed: Mar. 20, 2007

(51) Int. Cl. H01R 9/24

(52) U.S. Cl. 439/709

(57) ABSTRACT

Terminal block assemblies for electrical power distribution and methods of making such terminal block assemblies are provided. The terminal block assemblies include a terminal housing having a front side and a back side. The terminal housing defines at least one aperture therethrough with the aperture extending through the front side and the back side for receipt of an electrical connection within the terminal housing. At least one terminal is provided with the terminal configured to be securable to the electrical connection outside the terminal housing. At least one fastener device is provided for securing the terminal within the aperture of the terminal housing. The fastener device holds the terminal within the terminal housing with the terminal extending outward from the front side such that the electrical connection are fixed within the terminal housing.

### TECHNICAL FIELD

The subject matter described herein relates generally to terminal block assemblies for electrical power distribution. More particularly, the subject matter disclosed herein relates to easily assembled terminal block assemblies that permit attachment of terminals to wires outside the terminal block of a terminal block assembly.

### BACKGROUND

Terminal blocks provide a point of termination for wires coming from one piece of electrical equipment and extending on to another piece of equipment. Typically, the blocks include a number of terminals, such as studs or stamped plates with holes to accept screws. The studs may have attachment means like a nut at each end of the stud and the stamped plates may have screws to clamp a terminal to the stamped plate. The terminals are spaced apart at a uniform distance to prevent “creeping” of electrical voltage. A typical use of a terminal block is between a programmable controller and the equipment to be controlled. Another use is with ground fault equipment. Terminal blocks are also useful in electrical power distribution connections.

The number of terminals required in a terminal block varies widely depending upon the application. For example, some applications require a terminal block of as many as 20 separate termination points. Terminal blocks are typically injected molded with the terminals being inserted into the terminal block during the molding process such that the terminal block has terminals permanently residing therein. In such embodiments with the terminals being integrally incorporated into the terminal block, the wires must be attached to the terminals while the terminals are fastened within the terminal blocks. When the terminal block is already secured in the piece of equipment, connection of the wires to the terminals within the terminal block can become difficult.

Wires are often connected to terminal blocks by inserting the ends of stripped wires into cage clamps or spring clamps in the terminal block. A tool is used to depress the spring clamp or cage clamp to create an opening between the edge of the clamp and the edge of a terminal plate in the terminal block. When the clamp is released, the clamp returns to its original position and presses the end of the wire to the terminal plate. While such clamp connections are convenient for attaching the wires to the block, they are susceptible to the wires being pulled from the clamp or jarred loose from the clamp. Further, the connection between the wire and the terminal plate does not provide as good a surface contact to the wire for transmission of power as other terminal connection means since only a portion of one side contacts the terminal plate.

Commonly, terminal blocks employ ring terminals or other terminals for connecting wires to the block. A fastener, such as a binding head screw, is inserted through an opening in the block and also through an opening in the ring terminal to secure the wire to a press plate. While ring terminals and associated fasteners provide a more secure mechanical and electrical connection than cage clamps and spring clamps, they can be difficult to install and remove when connecting and disconnecting the wires to the block.

In such terminal block arrangements, a double terminal connection is effectively made that can weaken the transfer of power through the terminal blocks and thus between pieces of equipment. The terminal of the wire consists of the ring and must be attached to a stripped portion of the wire. Such terminal must then be secured through a screw to a terminal within the terminal housing of the terminal block. Thus, the terminal of the wire must be connected to the terminal of the terminal block, which is in turn connected to the terminal of the other piece of equipment. As it is commonly known, more connections and interconnections within electrical power distribution lines create greater amounts of interference and loss of power within those lines.

Therefore, a need exists for terminal block assemblies which can be easily installed and at the same time reduce the amount of interference and loss of power between pieces of equipment to be connected.

### SUMMARY

In the course of this disclosure, terminal assemblies and methods for creating terminal assemblies are provided.

According to one aspect of the present subject matter, a terminal block assembly for electrical power distribution is provided. The terminal block assembly includes a terminal housing having a front side and a back side. The terminal housing defines at least one aperture therethrough with the aperture extending through the front side and the back side for receipt of an electrical connection within the terminal housing. At least one terminal is configured to be securable to the electrical connection outside the terminal housing. At least one fastener device is provided for securing the terminal within the aperture of the terminal housing. The at least one fastener device holds the terminal within the terminal housing with the terminal extending outward from the front side of the terminal housing such that the electrical connection is fixed within the terminal housing.

According to another aspect of the present subject matter, the terminal block is provided for electrical power distribution. The terminal block includes a terminal housing having a front side and back side. The terminal housing can define a plurality of apertures therethrough with the plurality of apertures extending through the front side and the back side for receipt of a plurality of wires within the terminal housing. A plurality of free terminals may be provided with each terminal configured to be securable to a corresponding wire outside a terminal housing. A plurality of fastener devices are provided for securing the terminals to which the wires are attached within the apertures of the terminal housing. The fastener devices hold the terminals and wires within the terminal housing such that the terminals extend outward from the front side of the terminal housing. The fastener devices hold the terminals and the attached wires in a fixed position within the terminal housing.

According to another aspect of the present subject matter, a method of creating a terminal block is provided. The method includes providing a terminal housing having a front side and a back side, the terminal housing defining at least one aperture therethrough with the aperture extending through the front side and the back side. The method also includes providing an electrical connection and at least one terminal and securing the terminal to the electrical connection outside of the terminal housing. The method also includes inserting the terminal into and at least partially through the aperture within the terminal housing after the terminal is secured to the electrical connection. Further, the method includes fastening the terminal to the terminal housing.

According to a further aspect of the present subject matter, a method of creating a terminal block is provided. The method includes providing a terminal housing having a front side and back side. The terminal housing defines a plurality of apertures therethrough with the plurality of apertures extending through the front side and back side of the terminal housing. The method also includes providing a plurality of wires and securing a terminal to each wire of the plurality of wires such that the securement of the terminal to the wire is done outside of the terminal housing. The method also includes inserting each terminal of plurality of terminals into a corresponding aperture of the plurality of apertures in the terminal housing. Further, the method includes fastening the terminals to the terminal housing.

### BRIEF DESCRIPTION OF THE DRAWINGS

A full and enabling disclosure of present subject matter including a best mode thereof to one of ordinary skill in the art is set forth more particularly in the remainder of the specification, including reference to the accompany figures in which:

FIG. 1 shows a top plan view of an embodiment of the terminal block assembly according to the present subject matter;

FIG. 2 illustrates an exploded perspective view of the terminal block assembly according to FIG. 1;

FIG. 3A illustrates a front plan view of the terminal block assembly according to FIG. 1;

FIG. 3B illustrates a side plan view of the terminal block assembly according to FIG. 1;

FIG. 4A illustrates a front plan view of the terminal housing of the terminal block assembly according to FIG. 1;

FIG. 4B illustrates a back plan view of the terminal housing of the terminal block assembly according to FIG. 1;

FIG. 4C illustrates a front plan view of a terminal housing of an embodiment of a terminal block assembly according to the present subject matter;

FIG. 4D illustrates a front plan view of a terminal housing of an embodiment of a terminal block assembly according to the present subject matter;

FIG. 5A illustrates a back plan view of a terminal housing of an embodiment of a terminal block assembly according to the present subject matter;

FIG. 5B illustrates a perspective view of a portion of a terminal with fastener devices disposed thereon for used within an embodiment of a terminal block assembly according to the present subject matter; and

FIG. 6 illustrates front views of embodiments of fastener devices for use within an embodiment of a terminal block assembly according to the present subject matter.

### DETAILED DESCRIPTION OF THE INVENTION

Reference will now be made in detail to presently preferred embodiments of the present subject matter, one or more examples of which are shown in the Figures. Each example is provided to explain the subject matter and not as a limitation. In fact, features illustrated or described as part of one embodiment can be used in another embodiment to yield still a further embodiment. It is intended that the present subject matter covers such modifications and variations.

FIGS. 1, 2, 3A, and 3B illustrate a terminal block assembly, generally designated as 10, used to provide a point of termination for wires coming from a piece of electrical equipment. The terminal block assembly 10 includes a terminal housing 20 in which at least one terminal 30 may be held. In the illustrated embodiment, the terminal housing 20 provides four terminal positions, generally designated as 12, within the terminal block assembly 10. The number of terminal positions 12 provided in a terminal housing 20, however, may vary. For example, the number of terminal positions in a terminal housing may range from 1 to more than 100. An electrical connection, such as wires 40, may be secured to terminals 30 to provide the electrical connection with a termination point that is easily connectable to a power transmission device. Once each terminal 30 is connected to the electrical connection, the terminal 30 can be inserted into a terminal position in terminal housing 20. Instead of wires, other electrical connections, such as a bus bar or the like, may be used in connection with terminals 30.

Terminals 30 may be secured to wires 40 through connection portions 32. For example, once a wire 40 is prepared for receipt of a terminal 30, connection portion 32 of a terminal 30 can be secured to that wire 40 through crimping, soldering, screw securement or the like. The terminals 30 also include terminal connectors 34. When terminal block 10 is used within a piece of electrical equipment, terminal housing 20 is secured within the electrical equipment such that terminal connectors 34 extend outward in a position to allow terminal connectors 34 to be connected to another piece of electrical equipment or power transmission device through a connection means. Terminal connectors 34 can be different lengths and cross-sectional shapes to match the connectors to which each will be attached. Terminal connectors 34 can be threaded studs. Further, terminal connectors 34 can include threaded holes with matching screws to clamp terminals from other wires to the end.

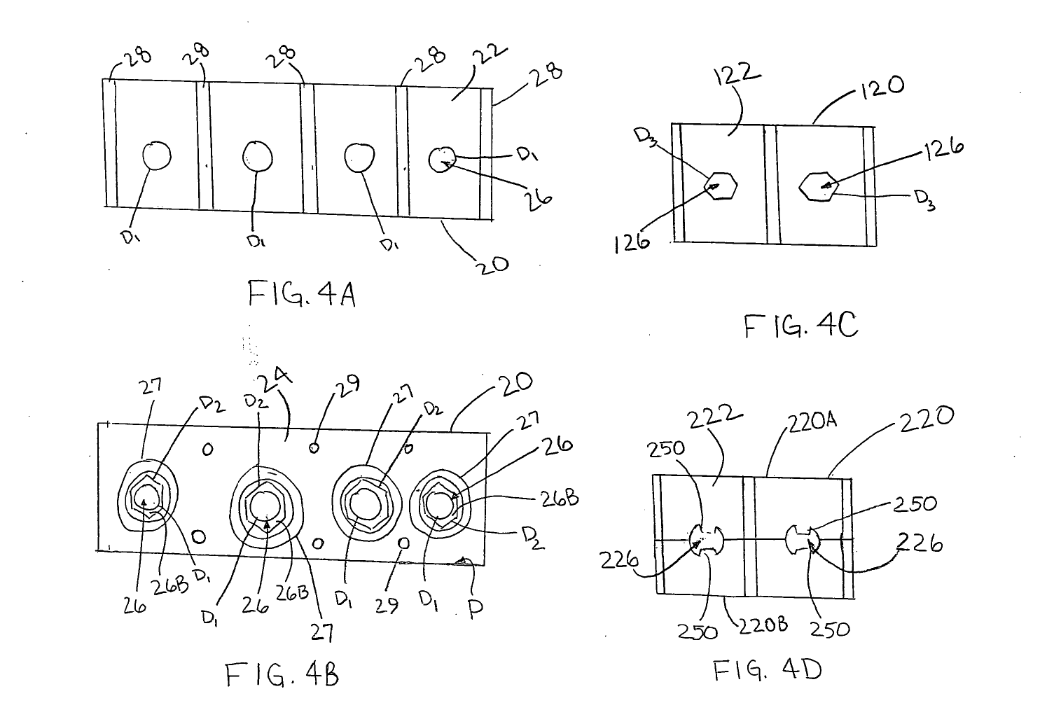

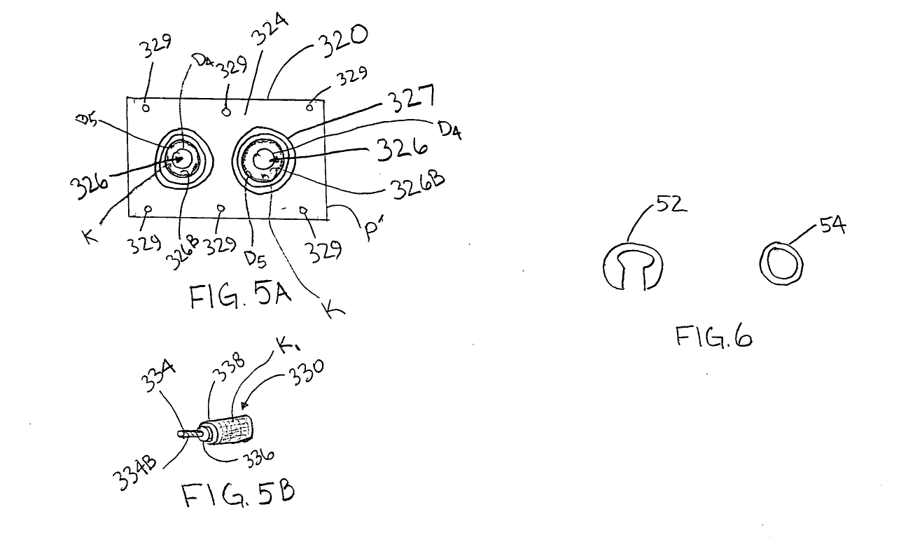

Terminal housing 20 includes a front side 22 and a back side 24. Once terminals 30 are secured to respective wires 40 by connection portions 32, terminals 30 can be inserted through apertures 26 that extend through terminal housing 20 from back side 24 to front side 22, or vice versa. Apertures 26, representatively shown in FIGS. 4A and 4B, can be spaced apart to provide adequate spacing between wires 40 for physical placement of wires 40 within terminal housing 20 as well as to help prevent interference that may occur between neighboring wires. Each aperture 26 can provide a seating 26B that prevents terminal 30 from passing all the way through the aperture 26, as will be explained in further detail below. Further, to help prevent possible interference between terminal connectors 34, terminal housing 20 may have barrier dividers 28 that are positioned between the apertures 26 on front side 22 of terminal housing 20. Barrier dividers 28 may also be positioned at either end of the terminal housing 20. Barrier dividers 28 may extend perpendicular to the front side 22 of terminal housing 20. Further, barrier dividers 28 may extend parallel to one another.

Terminal housing 20 can also include elevated perimeters 27 that surround the apertures 26 and extend outward from back side 24 of terminal housing 20. Elevated perimeters 27 can extend outward from back side 24 around apertures 26 to provide extra insulation to terminals 30 and wires 40 inserted into apertures 26 as will be explained in further detail below.

Once terminals 30 are inserted into apertures 26 within terminal housing 20 and terminals 30 abut against seatings 26B, fastener devices, such as fasteners 50, can be use to secure terminal 30 within terminal housing 20. Fastener devices will be described in more detail below.

To facilitate easier installment of wires 40 into terminal housing 20, the terminals 30 are secured to wires 40 before insertion of terminals 30 into terminal housing 20. The creation of terminal block assembly 10 can be explained with reference to FIG. 2.

Each wire 40 may have a sheath 42 that surrounds a core 44. Cores 44 may be, for example, a metal such as copper, gold, copper alloy or the like, which is conducive for use as a conductor. Sheaths 42 can be an insulative covering, which insulate cores 44 from the surrounding environment. Such sheaths 42 also can prevent interference between wires by reducing or eliminating the electromagnetic field created by electricity passing through cores 44 of wires 40. For preparing wires 40 for connection to their respective terminals 30 and subsequent insertion into terminal housing 20 to create terminal block assembly 10, ends 46 of wires 40 may be stripped of their sheaths 42 to expose cores 44. For each wire 40 to be inserted into terminal housing 20, sheath 42 can be removed from end 46 to expose enough of the metal core 44 of the wire 40 for proper connection to the respective terminal 30. Terminals 30 may be secured around ends 46 of wires 40 such that electrical conductivity between metal cores 44 and terminals 30 will occur. Terminals 30 may be secured to the wires 40 by, for example, crimping, soldering, screw securement, or the like.

In the embodiment shown in FIG. 2, each of the terminals 30 include a front portion 36 and a back portion 38. Extending from each respective front portion 36 is a terminal connector 34. Extending from each respective back portion 38 is a connection portion 32 in the embodiment shown. To secure a terminal 30 to a wire 40, connection portion 32 of the terminal 30 can surround the wire 40 and hold the terminal 30 to the wire 40. Each connection portion 32 can slide over the respective wire 40 such that the core 44 of the respective wire 40 comes into contact with the inner portion of the terminal 30 so as to be capable of transmitting electricity from the core 44 though the terminal connector 34 of the respective terminal 30. Inner portions of terminals 30 can surround cores 44 of wires 40 to provide maximum contact between cores 44 and terminals 30. Connection portions 32 in the embodiment shown may be crimped on to sheaths 42 of wires 40 to secure terminals 30 to wires 40. Crimping may be done through crimping pliers or the like. Such crimping methods provide secure attachment of terminal 30 to wire 40. Terminals 30 can also be secured to wires 40 by soldering metal cores 44 to terminals 30. In such an example, connection portions 32 may not have to extend outward from back portions 38 of terminals 30, but would rather be created inside terminals 30. For example, back portions 38 may be filled with molten solder. In such example, metal cores 44 on ends 46 may then be inserted into back portions 38 of terminals 30 to secure wires 40 thereto once the solder hardens.

Further, terminals 30 can have thread-forming screws extending therefrom which permit terminals 30 to be screwed into wires 40 to create a connection between cores 44 and terminals 30. Of note, the use of screws within terminals 30 to connect terminals 30 to wires 40 are beneficial to permit terminals 30 to be attached to busbars as well. In such embodiments, terminals 30 may be attached to wires, while others may be attached to busbars. By using thread-forming screws, terminals 30 can be connected to either wires or busbars.

Once wires 40 have been secured to corresponding terminals 30, the terminals 30 and wires 40 are now ready for insertion into terminal housing 20. Each terminal 30 can be inserted through a respective aperture 26 with a terminal connector 34 extending from front portion 36 of the terminal 30 placed in the respective aperture 26. Terminals 30 with wires 40 attach thereto can be inserted through apertures 26 until the terminals 30 abut seatings 26B of apertures 26 and terminal connectors 34 extend outward from front side 22 of terminal housing 20.

In the embodiment shown in FIGS. 1, 2, 3A, 3B, 4A and 4B, terminal block assembly 10 uses a matching feature element to aid in securing terminals 30 in terminal housing 20. The term “matching feature” refers to features or elements of the terminals and features or elements of the terminal housing that cooperate together to help hold the terminals axially in the terminal housing and/or can facilitate the prevention of rotation of the wires connected to the terminals.

As shown in FIG. 4B, apertures 26 may comprise two or more different shaped segments with first shaped segments D₁ extending through front side 22 of terminal housing 20 and second shaped segments D₂ extending through back side 24 of housing 20. First shaped segments D₁ and second segments D₂ can be any symmetrical or asymmetrical shaped segments that allow receipt of front portions 36 and back portions 38 of terminals 30. For example, second shaped segments D₂ may be larger cubic or cylindrical shaped segments, while first shaped segments D₁ may be truncated cone or pyramid shaped segments.

As in the embodiment shown in FIG. 4B, first shaped segments D₁ and second segments D₂ can have different cross-sectional shapes. First cross-sectional shaped segments D₁ can be of smaller cross-sectional areas than second cross-sectional shaped segments D₂, such that seatings 26B are formed within apertures 26. In this manner, a back portion 38 of terminal 30 having a cross-section larger than the cross-section of the front portion 36 of terminal 30 may be seated in the second cross-sectional shaped segment D₂ of the corresponding aperture 26 while abutting seating 26B within the aperture 26.

In such embodiments having apertures with at least two different cross-sectional shaped segments, first cross-sectional shaped segments D₁ of apertures 26 should be of a size and shape for accepting front portions 36 of terminals 30. Second cross-sectional shaped segments D₂ of apertures 26 should be of a size and shape for accepting back portions 38 of terminals 30. First cross-sectional shaped segments D₁ of apertures 26 can be centered within second cross-sectional shaped segments D₂ in some embodiments. In any event, first cross-sectional shaped segments D₁ should be accessible through second cross-sectional shaped segments D₂ to permit insertion of front portions 36 of terminals 30 through first cross-sectional shaped segments D₁.

Further, back portion 38 of each terminal 30 may have a shape or cross-sectional shape that may help to prevent rotation of the wire 40 attached thereto once the terminal 30 is seated within its corresponding aperture 26. To help facilitate this, the second cross-sectional shaped segment D₂ of the respective aperture 26 may have the same shape as the back portion 38 of the terminal 30. For example, the back portion 38 of the terminal 30 and the second cross-sectional shaped segment D₂ of the aperture 26 may have mating hexagonal, octagonal, square, or non-symmetrical cross-sectional shapes that prevent rotation of wire 40 once back portion 38 of terminal 30 is seated within the respective aperture 26 terminal housing 20. Further, back portion 38 of terminal 30 may have a three-dimensional feature that interacts with a three-dimensional feature of terminal housing 20 to hold the terminal 30 and wire 40 in place.

As shown in the embodiment depicted in FIGS. 1, 2, 3A, 3B, 4A and 4B, for example, first cross-sectional shaped segments D₁ of apertures 26 can be a circular cross-sectional, while second cross-sectional shaped segments D₂ of apertures 26 can be a hexagonal shape as seen in FIG. 4B. Terminals 30 can have front portions 36 having corresponding circular cross-sectional shaped segments to that of first cross-sectional shaped segments D₁ of apertures 26, and terminals 30 can have back portions 38 having corresponding hexagonal cross-sectional shaped segments to that of second cross-sectional shaped segments D₂ of apertures 26. Once terminals 30 are seated in apertures 26, second cross-sectional shaped segments D₂ of apertures 26 and the hexagonal cross-sectional shaped segments of back portions 38 fitted together to prevent terminals 30, and thus wires 40, from rotating. As stated above, by having the second cross-sectional shaped segments D₂ larger then first cross-sectional shaped segments D₁ of apertures 26, seatings 26B are created that, in conjunction with fastener devices, help to hold terminal 30 within terminal housing 20.

Each terminal 30 can have a groove 39 that extends around front portion 36. When terminals 30 are inserted into apertures 26, front portions 36 extend out far enough that grooves 39 extend just past front side 22 of terminal housing 20. At the same time, back portions 38 abut seatings 26B to prevent further insertion of terminals 30 through apertures 26. At this point, in the embodiment shown, fastener devices, such as fasteners 50 may be secured within grooves 39 such that fasteners 50 in cooperation within seatings 26B hold terminals 30 within terminal housing 20.

Fasteners 50 can be e-clips, which have thick elastic sides and a spiked extension that extends from an apex of the e-clips when the thick sides are pointing downward as shown in FIG. 2. In the embodiment shown in FIG. 2 of terminals 30, any fastener which holds terminals 30 within terminal housing 20 can be used. For example, C-clamps 52 or O-rings 54 as shown in FIG. 6 can be used to interact with grooves 39 to hold terminals 30 in place within terminal housing 20. However, other fastener devices are contemplated for use with a terminal block assembly 10. For example, the fastener devices may be knurls formed on the outer surfaces of terminals 30 and/or inner surfaces of apertures 26. Further, the fastener devices can be other types of clamps or clips, friction bonds created by other friction creating mechanisms, bonds formed by ultrasonic welding, melt bonds formed by heat-bonding, matching features in the terminal housing 20 and terminals 30, or the like.

As stated above, back portions 38 may have larger cross-sections than front portions 36 of terminals 30 to help secure terminals 30 within terminal housing 20 in cooperation with fasteners 50. In this manner, when fasteners, in the form of clips, clamps, or O-rings are used to fit within respective grooves 39 around front portions 36 of terminals 30 as they extend past front side 22 of terminal housing 20, back portions 38 can abut against seatings 26B within the corresponding apertures 26. Alternatively, in other embodiments, back portions 38 may abut against back side 24 of terminal housing 20 within elevated perimeters 27 extending around the respective back portions 38. In this manner, back portions 38 prevent terminals 30 from being pushed further through apertures 26, while the fasteners in the form of the clips, clamps, or O-rings have a diameter or shape that prevents terminals 30 from being pulled backwards out of apertures 26 of terminal housing 20.

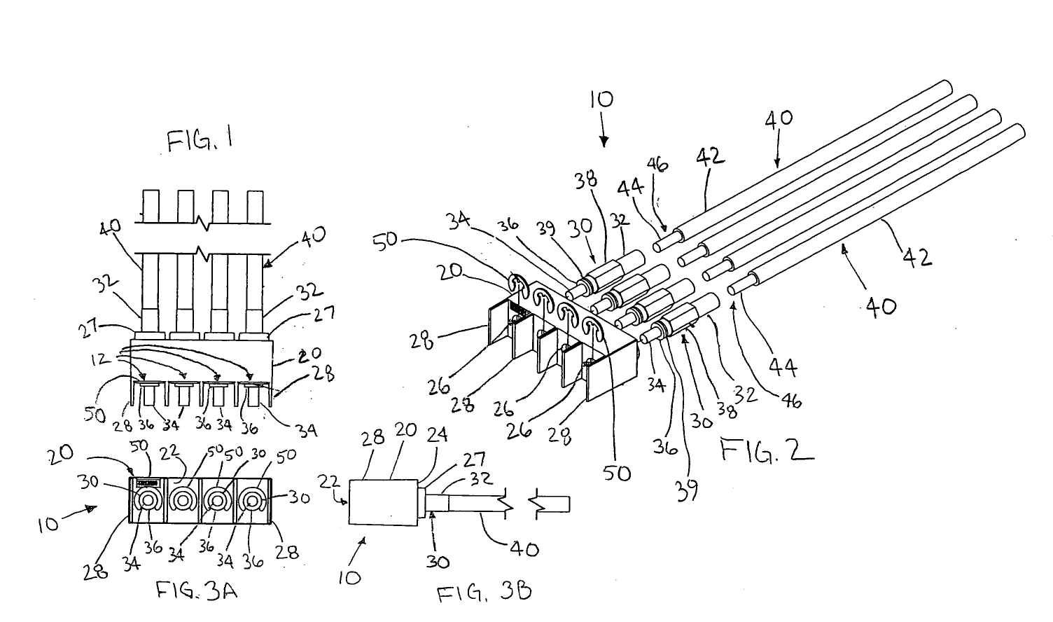

FIGS. 3A and 3B show a front view and a side view, respectively, of terminal block assembly 10 when it is fully assembled. Wires 40 extend outward from back side 24 of terminal housing 20. Terminal connectors 34 of terminals 30 extend outward from front side 22 of terminal housing 20. Front portions 36 of terminals 30 extend out from front side 22 of terminal housing 20, while back portions 38 of terminals 30 abut firmly against the seatings within the apertures (not shown). The fastening devices 50 are placed within grooves 39 of front portions 36 which extend out past the front side 22 of terminal housing 20. In this manner, wires 40 are firmly held in place. Barrier dividers 28 partition each terminal connector 34. Each barrier divider 28 can extend past the point were the terminal connectors 34 extend out from front side 22 of terminal housing 20.

Further, as shown in FIG. 4C and FIG. 4D, alternative embodiments of a terminal housing can be used which provide different shaped apertures for different shaped terminals. For example, both the front portion and back portion of the terminal may be a shape that prevents rotation of the wire to which the terminal is attached. As shown in FIG. 4C, for example, each aperture 126 may have a hexagonal shape for a first cross-sectional shaped segment D₃ on front side 122 of terminal housing 120 while a second cross-sectional shaped segment of each aperture 126 on the back side (not shown) of terminal housing 120 may have the same or different cross-sectional shape, such as a circular cross-section, an octagonal cross-section, a square or rectangular cross-section, or an asymmetrical cross-section. The back portion of a terminal as well as the second cross-sectional shaped segment of each aperture 126 may be larger in cross-sectional area than the first cross-sectional shaped segment D₃ of the aperture 126.

As discussed above, each aperture 126 can have a single diameter or cross-sectional shape. In such case, the back portion of the terminals may abut the back side of terminal housing 120. Alternatively, the back portions and front portions of the terminals to be inserted into the single cross-sectional apertures 126 may have the same cross-sectional shaped segment as the aperture 126. The terminals can be insertable into the single cross-section shaped apertures 126 with fasteners being positioned on the terminals on both sides of the aperture to prevent both the unintentional pulling through and pushing out of the terminal.

As shown in FIG. 4D, the fastener devices may be formed by a cross-sectional shape of the aperture 226 formed within terminal housing 220. For example, front side 222 of terminal housing 220 may define thin clip extensions 250 within aperture 226 extend partially into aperture 226. When a terminal having a groove around its outer surface is placed within aperture 226, the fastener devices, in the form of the extensions 250, may fit into the groove to hold the terminal in place. In such embodiments, the terminal to be inserted may have the same cross-sectional shaped front portion and back portion. These fastener devices in the form of extensions 250 serve to hold the terminal and wires in place within terminal housing 220 such that terminal can not be pushed forward or pulled back through the apertures 226 without an intentionally exerted force. Therefore, unintentional removal of the wire from a terminal housing 220 would be unlikely. It is contemplated that such clip extensions 250 could be formed by terminal housing 220 anywhere within apertures 226.

Terminal housing 220 can comprise two or more components that can be secured together. For example, terminal housing 220 can comprise a first terminal housing component 220A and a second terminal component housing 220B that can be secured together through snaps, adhesives, matching features contained within the terminal housing components, or the like. By using such terminal housing components 220A and 220B, the terminals can be placed in one terminal housing component after connection to an electrical connection. The other terminal housing component can then be secured to the terminal housing component containing the terminals. During placement of the terminals within the terminal housing components and securement of the terminal housing components together, the fastener devices on the terminal housing component are aligned and/or matched with any corresponding features on the terminals. In this manner, the terminals can be secured in the terminal housing.

FIGS. 5A and 5B illustrate portions of a further embodiment of a terminal block assembly. Terminal housing 320 has two apertures 326 formed therein. Each aperture 326 comprises two different cross-sections. First circular cross-sectional segments D₄ extend through the front side (not shown) of terminal housing 320, while second circular cross-sectional segments D₅ extend through back side 324. Second circular cross-sectional segments D₅ have greater diameters than first circular cross-sectional segments D₄ such that seatings 326B are formed. To secure terminals 330 in terminal housing 320, apertures 320 and/or terminals 330 can have fastener devices, such as knurls, that create frictional engagements that hold the terminals 330 in terminal housing 320. For example, the inner surfaces of second circular cross-sectional segments D₅ may have knurls K formed thereon. The diameters of back portions 338 of terminals 330 and the diameters of second circular cross-sectional segments D₅ are closely similar in size, such that knurls K can prevent rotation of terminals 330 that are inserted into apertures 326 of terminal housing 320. Further, such knurls K prevent terminals 330 from being pulled through and pushed out of apertures 326 of terminal housing 320.

Outer perimeter P′ of back side 324 of terminal housing 320 can have mounting holes 329 for securing terminal housing 320 of the terminal block assembly to a frame of the electrical equipment in which it is used. Elevated perimeters 327 surround apertures 326 and extend outward from back side 324. Elevated perimeters 327 insulate terminals 330 and the wires attached thereto that are inserted into the respective apertures 326 from the frame and from the other terminals and wires within terminal housing 320.

Terminal 330 shown in FIG. 5B is representative of the terminals that can be inserted into housing 320. Front portion 336 of terminal 330 can be inserted through first circular cross-section D₄ of aperture 326, while back portion 338 of terminal 330 fits tightly into second circular cross-section D₅. Back portion 338 can have knurls K1 on its outer surface that, as described above, can be used to hold terminal 330 within a respective aperture 326 of terminal housing 320. A terminal connector 334, which is used to connect terminal 330 to power transmission devices, can extend from front portion 336. Terminal connector 334 can have screw threads formed therearound to provide a connection means for securing connecting terminal connector 334 to such power transmission devices.

Referring back to FIGS. 4B, mounting holes 29 may be defined in back side 24 of terminal housing 20 that can be used to secure terminal block assembly 10 to the electrical process equipment within which it is to be used. Mounting holes 29 can be positioned near perimeter P of back side 24 of terminal housing 20. Similarly, as shown in FIG. 5A, mounting holes 329 can be defined near perimeter P′ of back side 324 of terminal 320. By the use of the specific mounting holes 29, 329 which are defined in back sides 24, 324 of terminal housings 20, 320, spatial concerns regarding the terminal block assemblies can be addressed. Unnecessary use of space is prevented by not having to use ears that would extend from the outer perimeters of the housing to secure the housing to the processing equipment as is normally done with current terminal blocks. In this matter, more efficient use of space may be accomplished on the processing equipment.

Further, the mounting holes 29, 329 are placed in perimeter P, P′ of terminal housing 20, 320 outside of elevated perimeters 27, 327 that surround apertures 26, 326. Elevated perimeters 27, 327 extend past mounting holes 29, 329 to insulate terminals 30 and wires 40 inserted into terminal housing 20, 320 from exposure to the frame of the electrical equipment in which the terminal block assembly is used. When screws, or other connection devices, are placed within mounting holes 29, 329 to attach the terminal block assembly to the frame, the frame will abut against back side 24, 324 along perimeter P, P′ of terminal housing 20, 320, while elevated perimeters 27, 327 extend outward past the frame and into the electrical equipment.

Through the use of terminal block assemblies shown in the disclosed embodiments, an easier assembly of a power distribution system in electrical equipment can be accomplished than with current terminal blocks being used. Terminal block assemblies are easier to assemble and install and require less handling and manipulation as well as time to assemble. If need be, it is conceivable that assembly of such terminal block assemblies can be easily automated to increase productivity in assembling electrical equipment that use such terminal block assemblies. Further, by securing the terminals to the wires before inserting them within the terminal housings, greater contact surface between the wires and the terminals can be achieved, thereby lowering the resistance within the circuit created by the wires and terminals. Better and easier dissipation of heat and other energy may also occur in such terminal block assemblies.

The embodiments of the present disclosure shown in the drawings and described above are exemplary of numerous embodiments that can be made within the scope of the appending claims. It is contemplated that the configurations of the terminal block assemblies and the methods of making such terminal block assemblies comprise numerous configurations other than those specifically disclosed. Thus, it is applicants' intention that the scope of the patent issuing herefrom will only be limited by the scope of the appending claims.

What is claimed:

1. A terminal block assembly for electrical power distribution, the terminal block assembly comprising:
(a) a terminal housing having a front side and a back side, the terminal housing defining at least one aperture therethrough with the aperture extending through the front side and the back side for receipt of an electrical connection within the terminal housing;
(b) at least one terminal configured to be securable to the electrical connection outside the terminal housing; and
(c) at least one fastener device for securing the terminal within the aperture of the terminal housing, the at least one fastener device holding the terminal within the terminal housing with the terminal extending outward from the front side of the terminal housing such that the electrical connection is fixed within the terminal housing.

2. The terminal block assembly as in claim 1, wherein the aperture of the terminal housing and the terminal comprise matching features that work in cooperation with the fastener device to secure the terminals within the terminal housing.

3. The terminal block assembly as in claim 2, wherein the aperture within the terminal housing is sized to permit only a portion of a terminal to extend therethrough.

4. The terminal block assembly as in claim 2, wherein the aperture comprises at least two different shaped segments.

5. The terminal block assembly as in claim 4, wherein a first shaped segment of the aperture extends through the front side of the terminal housing and a second shaped segment of the aperture extends through the back side of the terminal housing.

6. The terminal block assembly as in claim 5, wherein the first shaped segment and second shaped segment of the aperture define a seating within the aperture.

7. The terminal block assembly as in claim 5, wherein the terminal has a front portion that is insertable through the first shaped segment and a back portion that is insertable into the second shaped segment such that the back portion abuts a seating within the aperture that is defined by the first shaped segment and second shaped segment of the aperture.

8. The terminal block assembly as in claim 4, wherein a first shaped segment of the aperture comprise a first cross-sectional shape and a second shaped segment of the aperture comprise a second cross-sectional shape, the first shaped segment and second shaped segment of the aperture defining a seating within that aperture.

9. The terminal block assembly as in claim 8, wherein a front portion of the terminal comprise a cross-sectional shape corresponding to the first cross-sectional shape of the first shaped segment of the aperture and a back portion of the terminal comprise a cross-sectional shape corresponding to the second cross-sectional shape of the second shaped segment of the aperture.

10. The terminal block assembly as in claim 8, wherein at least one of the first cross-sectional shape of the first shaped segment of the aperture or the second cross-sectional shape of the second shaped segment of the aperture prevents rotation of the terminal inserted within the aperture.

11. The terminal block assembly as in claim 1, wherein the terminal housing comprises mounting holes defined along a perimeter of the back side of the terminal housing and an elevated perimeter that surrounds the aperture, the elevated perimeter extending outward from the back side of the terminal housing.

12. The terminal block assembly as in claim 1, wherein the terminal comprises a larger back portion than a front portion.

13. The terminal block assembly as in claim 12, wherein the terminal housing defines a seating within the aperture against which the larger back portion of the terminal abuts upon insertion into the aperture.

14. The terminal block assembly as in claim 12, wherein the back portion of each terminal comprises a different shape than the front portion.

15. The terminal block assembly as in claim 14, wherein the shape of the back portion of the terminal prevents rotation of the terminal within the aperture in which it is inserted.

16. The terminal block assembly as in claim 1, wherein the at least one aperture comprises a plurality of apertures and the at least one terminal comprises a plurality of terminals.

17. The terminal block assembly as in claim 16, wherein the at least one fastener device comprises a plurality of fastener devices for securing the terminals within the apertures of the terminal housing, the fastener devices holding the terminals within the terminal housing with the terminals extending outward from the front side of the terminal housing.

18. The terminal block assembly as in claim 16, wherein the electrical connection comprises a plurality of wires with each terminal configured to be securable to a corresponding wire outside the terminal housing.

19. The terminal block assembly as in claim 16, wherein the terminal housing has barrier dividers placed between the apertures.

20. The terminal block assembly as in claim 1, wherein the terminal is configured to receive at least a portion of the fastener device thereon.

21. The terminal block assembly as in claim 1, wherein the fastener device comprises at least one of a clamp, an e-clip, an o-ring, knurls, friction bonds, ultrasonic bonds, or melt bonds.

22. The terminal block assembly as in claim 16, wherein the terminal housing comprises at least two components that are securable together.

23. A terminal block assembly for electrical power distribution, the terminal block assembly comprising:
(a) a terminal housing having a front side and a back side, the terminal housing defining a plurality of apertures therethrough with the plurality of apertures extending through the front side and the back side for receipt of a plurality of wires within the terminal housing;
(b) a plurality of terminals with each terminal configured to be securable to a corresponding wire outside the terminal housing; and
(c) a plurality of fastener devices for securing the terminals within the apertures of the terminal housing, the fastener devices holding the terminals within the terminal housing with the terminals extending outward from the front side of the terminal housing such that the wires are fixed within the terminal housing.

24. The terminal block assembly as in claim 23, wherein the plurality of apertures of the terminal housing and the plurality of terminals comprise matching features that work in cooperation with the plurality of fastener devices to secure the terminals within the terminal housing.

25. The terminal block assembly as in claim 24, wherein each aperture within the terminal housing is sized to permit only a portion of a terminal from the plurality of terminals to extend therethrough.

26. The terminal block assembly as in claim 24, wherein the plurality of apertures each comprise at least two different shaped segments.

27. The terminal block assembly as in claim 26, wherein a first shaped segment of each aperture extends through the front side of the terminal housing and a second shaped segment of each aperture extends through the back side of the terminal housing.

28. The terminal block assembly as in claim 27, wherein the first shaped segment and second shaped segment of each aperture define a seating within that aperture.

29. The terminal block assembly as in claim 27, wherein each terminal has a front portion that is insertable through the first shaped segment and a back portion that is insertable into the second shaped segment such that the back portion abuts a seating within the corresponding aperture that is defined by the first shaped segment and second shaped segment of the corresponding aperture.

30. The terminal block assembly as in claim 26, wherein a first shaped segment of each aperture comprise a first cross-sectional shape and a second shaped segment of each aperture comprise a second cross-sectional shape, the first shaped segment and second shaped segment of each aperture defining a seating within that aperture.

31. The terminal block assembly as in claim 30, wherein the front portions of terminals comprise a cross-sectional shape corresponding to the first cross-sectional shape of the first shaped segments and the back portions comprise a cross-sectional shape corresponding to the first cross-sectional shape of the second shaped segments.

32. The terminal block assembly as in claim 30, wherein at least one of the first cross-sectional shape of the first shaped segments or the second cross-sectional shape of the second shaped segments prevents rotation of the terminals inserted within the apertures.

33. The terminal block assembly as in claim 23, wherein the terminal housing has barrier dividers placed between the apertures.

34. The terminal block assembly as in claim 23, wherein the terminal housing comprises mounting holes defined along a perimeter of the back side of the terminal housing and elevated perimeters that surround the plurality of apertures, the elevated perimeter extending outward from the back side of the terminal housing.

35. The terminal block assembly as in claim 23, wherein each terminal comprises a larger back portion than a front portion.

36. The terminal block assembly as in claim 35, wherein the terminal housing defines a seating within each aperture of the plurality of apertures against which the larger back portion of a terminal from the plurality of terminals abuts upon insertion into a corresponding aperture.

37. The terminal block assembly as in claim 35, wherein the back portion of each terminal comprises a different shape than the front portion.

38. The terminal block assembly as in claim 37, wherein the shape of the back portion of each terminal prevents rotation of the terminal within the aperture in which it is inserted.

39. The terminal block assembly as in claim 23, wherein the terminal is configured to receive at least a portion of the fastener device thereon.

40. The terminal block assembly as in claim 23, wherein the fastener device comprises at least one of a clamp, an e-clip, an o-ring, knurls, friction bonds, ultrasonic bonds, or melt bonds.

41. The terminal block assembly as in claim 16, wherein the terminal housing comprises at least two components that are securable together.

42. A method of creating a terminal block, said method comprising:
(a) providing a terminal housing having a front side and a back side, the terminal housing defining at least one aperture therethrough with the aperture extending through the front side and the back side;
(b) providing an electrical connection and at least one terminal;
(c) securing the terminal to the electrical connection outside of the terminal housing;
(d) inserting the terminal into and at least partially through the aperture within the terminal housing after the terminal is secured to the electrical connection; and
(e) fastening the terminal to the terminal housing.

43. The method of claim 42, wherein the step of fastening the terminal to the terminal housing further comprises attaching a fastener to the terminal after insertion within the respective aperture.

44. The method of claim 43, wherein the step of fastening the terminal to the terminal housing further comprises inserting the terminal into the aperture such that a back portion of the terminal abuts against a seating defined within the aperture.

45. The method of claim 42, wherein the step of fastening the terminal to the terminal housing further comprises matching features of the terminal with features of the aperture into which it is inserted.

46. A method of creating a terminal block, said method comprising:
(a) providing a terminal housing having a front side and a back side, the terminal housing defining a plurality of apertures therethrough with the plurality of the apertures extending through the front side and the back side;
(b) providing a plurality of wires and a plurality of terminals;
(c) securing each terminal of the plurality of terminals to a wire of the plurality of wires outside of the terminal housing;
(d) inserting each terminal of the plurality of terminals into and at least partially through an aperture of the plurality apertures within the terminal housing after the terminal is secured to a wire of the plurality of the wires; and
(e) fastening the terminals to the terminal housing.

47. The method of claim 46, wherein the step of fastening the terminals to the terminal housing further comprises attaching a fastener device to each terminal after insertion within the respective aperture.

48. The method of claim 47, wherein the step of fastening the terminals to the terminal housing further comprises inserting each terminal into the respective aperture such that a back portion of the terminal abuts against a seating defined within the aperture in which the terminal is inserted.
